(19) United States
(12) Patent Application Publication
(10) Pub. No.: US 2007/0272808 A1
(43) Pub. Date: Nov. 29, 2007

(54) Multi-dimensional adjustable head support for shoulder arthroscopy chairs

(76) Inventor: Peter Schuerch, Quincy, MA (US)

Correspondence Address: John M. Brandt, 60 Thaxter St., Hingham, MA, 02043, US

(21) Appl. No.: 11/440,589

(22) Filed: May 25, 2006

(51) Int. Cl. B68G 5/00

(52) U.S. Cl. 248/118

(57) ABSTRACT

A multi-dimensional adjustable surgical head support adapted to attach to the upper body support of a shoulder arthroscopy chair consisting of a generally vertically disposed rail or bar attached to the upper body support by a swivel joint assembly, a plate slideably mounted on the bar and a head support attached to the plate by another swivel joint assembly. Appropriate clamps are provided to secure each swivel joint and the sliding plate.

The slideable plate provides height adjustment of the head support and the two swivel joints provide attitude adjustment about generally perpendicular vertical and horizontal axis.

### BACKGROUND OF THE INVENTION

1. Field of the Invention

The invention resides in the field of head supports for surgical procedures and more particularly relates to supports adjustable in multi-dimensions over a selected range of positions.

2. Description of the Prior Art

Rudimentary head supports and restraints exist in the marketplace for use with surgical appliances of the type described herein. The applicant is unaware of any device which allows positioning or adjustment in a plurality of dimensions as will be described below

### SUMMARY OF THE INVENTION

The invention may be summarized as a multi-dimensional adjustable head support to be used during surgical procedures in which the height and angular orientation or attitude of the support may be varied and locked in place to accommodate the head characteristics and position of individual patients. In certain upper body surgical procedures, it is important to immobilize the patient as much as possible to prevent injury and interference during the operation. To that end, shoulder arthroscopy chairs including head supports are available to provide upper body support and access for surgery on shoulders and other adjacent body components.

The head support disclosed herein is adapted to provide maximum flexibility to accommodate patients of various heights and to allow the positioning of the head as best suits the procedure at hand. The distal end is composed of a swivel joint, a ball joint for example, affixed to the upper body support of an appropriate chair adapted for surgical procedures.

Attached to the swivel joint is a bar extending generally in an upright or vertical direction. The bar is arranged to pivot about the point of attachment of the joint to the chair. A clamp such as a handle actuated rotatable bolt is used to secure the joint and bar in a desired position. A plate, to which a second swivel joint such as a ball joint is attached, is slideably mounted on the bar and is fixed at a desired position along the bar by a clamp such as a handle actuated rotatable bolt similar to that which locks the bar in place in relation to the chair.

A head support is attached to the second swivel joint which has freedom of movement about an axis generally horizontal or perpendicular to that of the bar and the first swivel joint. The second swivel joint is also secured by a clamp, suitably of the same configuration of handle and bolt as described above.

These and other features and advantages of the invention will become more clear from the description of the preferred embodiment and drawings which follow.

### DESCRIPTION OF THE DRAWINGS

FIG. 1 is a perspective view of the preferred embodiment of the invention;

FIG. 2 is a side view of the embodiment of FIG. 1;

FIG. 3 is a cross-sectional front view in detail of a component of FIG. 1; and

FIG. 4 is a cross-sectional side view of the component of FIG. 3.

### DESCRIPTION OF THE PREFERRED EMBODIMENT

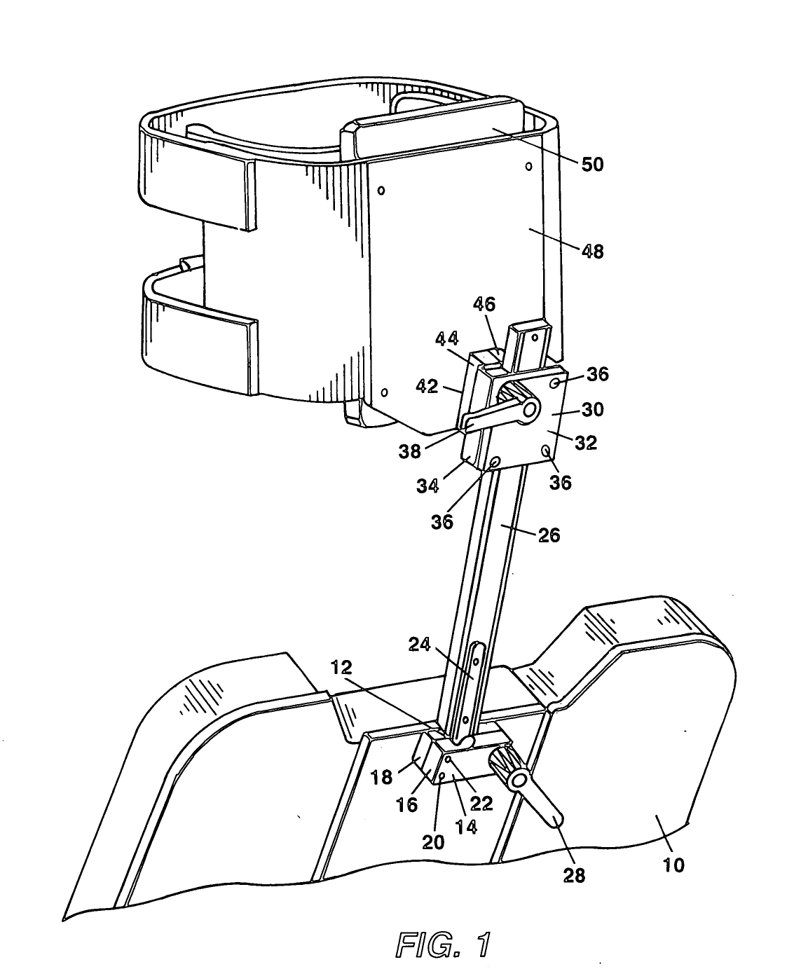

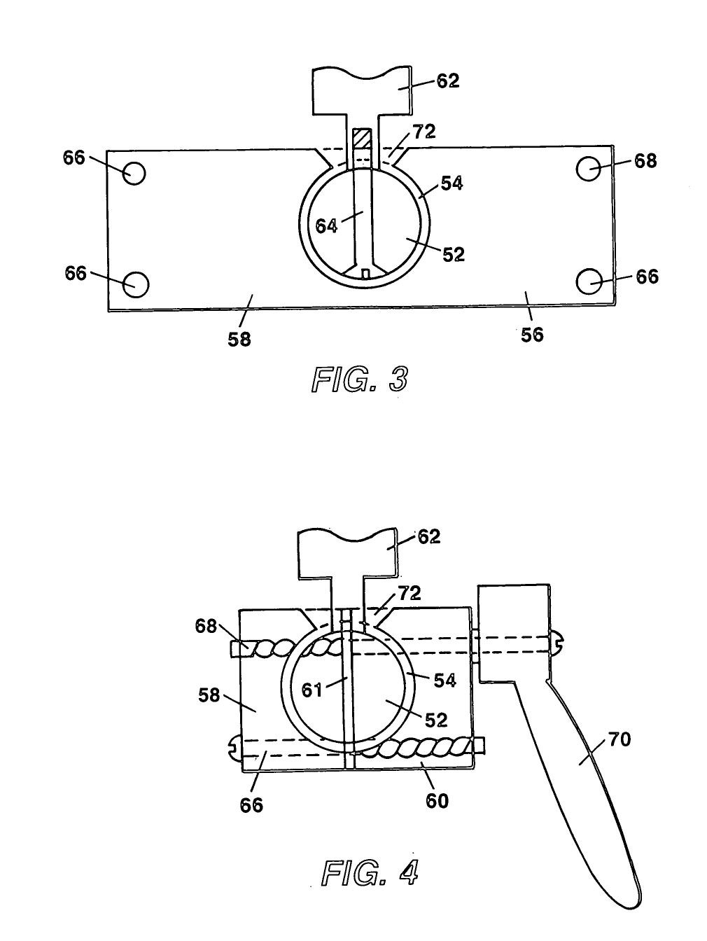

Referring to FIG. 1, there is shown a perspective view of the preferred embodiment of the invention viewed from the back of a shoulder arthroscopy chair upper body support platform 10. A swivel joint 12, a ball joint for example, consisting of a socket and ball not shown in FIG. 1 but illustrated in detail in FIGS. 3 and 4 and disposed inside split plate 14 formed of sections 16 and 18, is attached to support 10 by screws 20 and 22.

Rail or bar 26 is connected to the ball by bridge plate 24 and is generally disposed in an upright or vertical position. Bar 26 is free to rotate about the pivot provided by the ball joint within the confines of the assembly and is locked in a desired position by rotatable handle clamp 28 which functions to squeeze the ball in the socket between plate sections 16 and 18.

A second split plate 30 is slideably mounted on bar 26 and consists of plate sections 32 and 34 joined by bolts 36. Plate 30 is free to move up and down bar 26 to adjust to a desired height and is secured in place by rotatable handle clamp 38.

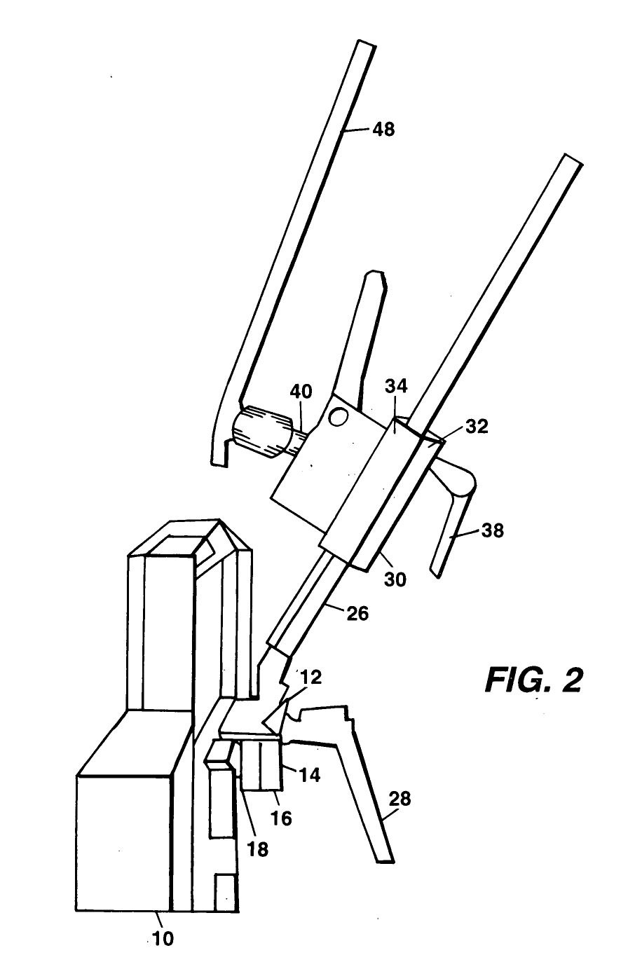

Further illustrating the components of the invention, FIG. 2 is a side view of the embodiment of FIG. 1 in which like numbers refer to like components. A second swivel joint 40, also a ball joint to be illustrated in detail below, is disposed in split plate 42 consisting of sections 44 and 46. Joint 40 functions in the same manner as swivel joint 12 as described above and as will be further shown. This swivel joint is arranged to move about an axis generally perpendicular, i.e., in a horizontal attitude, in relation to the first swivel joint. Attached to joint 40 is head support 48 to which apparatus for securing a patient's head such as head enclosure 50 may be affixed.

FIGS. 3 and 4 illustrate in detail a typical construction arrangement for the ball joints comprising the swivel joints 12 and 40 described above. FIG. 3 shows a cross-sectional front view of an arrangement in which ball 52 is disposed in socket 54 in split plate assembly 56 composed of sections 58 and 60, one-half of which is shown in the drawing. Extension 62 secured to ball 52 by bolt 64, not shown in FIG. 4 for purposes of clarity, extends above assembly 56 and is used to mount plate 24 or head support 48 as described above.

As further shown in FIG. 4, split plate components 58 and 60 are slightly separated by space 61 and joined by bolts 66, as well as by bolt 68 attached to handle 70 which is rotated to squeeze or release sections 58 and 60. Bolts 66 are tightened to provide ball 52 just sufficient space to rotate within socket 54 when bolt 68 is released by handle 70, the amount of rotation being limited by relief cone 72 provided in assembly 56 above ball 52.

In operation, the head support component to be positioned is therefore freed from restraint by rotation of handle 70, moved to the desired orientation, and then secured by the rotation of handle 70 in the opposite direction to clamp ball 52 in socket 54 within assembly 56.

As variations in the above described preferred embodiment will now become obvious to those skilled in the art, the invention is accordingly defined by the following claims.

What is claimed is:

1. A multi-dimensional adjustable head support system for a shoulder arthroscopy chair having an upper body support platform, said head support system comprising in combination:
A. a first swivel joint attached to said upper body support;
B. first swivel joint clamping means for securing said first swivel joint;
C. a bar attached to said first swivel joint disposed in a generally vertical upright position;
D. a plate slideably mounted on said bar;
E. plate clamping means for securing said plate at a selected position along said bar;
G. a second swivel joint attached to said plate;
I. second swivel joint clamping means for securing said second swivel joint; and
J. a head support attached to said second swivel joint.

2. The head support system of claim 1 wherein said first and second swivel joints comprise ball joints, each consisting of ball and socket.

3. A multi-dimensional adjustable head support system for a shoulder arthroscopy chair having an upper body support platform, said head support system comprising in combination:
A. a first ball joint socket attached to said upper body support platform for receiving a ball member:
B. a first ball member disposed in said socket;
C. first ball joint clamping means for immobilizing said ball;
D. a bar attached to said first ball member disposed in a generally vertical upright position;
E. a plate slideably mounted on said bar;
F. plate clamping means for immobilizing said plate at a selected position along said bar;
G. a second ball joint socket attached to said plate for receiving a ball member;
H. a second ball member disposed in said second socket;
I. second ball joint clamping means for immobilizing said second ball member; and
J. a head support attached to said second ball member.
